(19) United States
(12) Patent Application Publication
(10) Pub. No.: US 2010/0040920 A1
(43) Pub. Date: Feb. 18, 2010

(54) METHOD FOR DETERMINING A STATE OF A REFORMER IN A FUEL CELL SYSTEM

(75) Inventors: Stefan Kading, Zerrinthin (DE); Su Zhou, Shanghai (CN)

Correspondence Address: DICKINSON WRIGHT PLLC, 1875 Eye Street, NW, Suite 1200, WASHINGTON, DC, 20006, US

(73) Assignee: ENERDAY GmbH, Stockdorf (DE)

(21) Appl. No.: 12/440,211

(22) PCT Filed: Jul. 20, 2007
(86) PCT No.: PCT/DE07/01290

§ 371 Date: Mar. 5, 2009

(30) Foreign Application Priority Data
Sep. 13, 2006 (DE) 10 2006 043 037.9

(51) Int. Cl. H01M 8/04; G01N 27/416

(52) U.S. Cl. 429/22; 324/426

(57) ABSTRACT

The invention relates to a method for diagnosing a condition of a reformer (16) in a fuel cell system.

In accordance with the invention it is provided for that diagnosing the condition of the reformer (16) is performed on the basis of one or more predefined characteristics correlating with an conversion degree.

The invention relates to a method for determining a state or a condition, respectively, of a reformer, in a fuel cell system.

In addition, the invention relates to a fuel cell system including a controller.

Known generally are fuel cell systems, for example, solid oxide fuel cell (SOFC) systems, in which a reformer, a fuel cell or a fuel cell stack and an afterburner are coupled to each other in this sequence. The reformer reacts its supply of air and fuel into a hydrogenated and monocarbonated gas respectively into a reformate. This reformate then gains access to an anode of the fuel cell or of the fuel cell stack. More particularly, the reformate is supplied via an anode inlet to the fuel cell stack. In the anode the reformate (H₂, CO) is partly oxidized catalytically with electron emission and exhausted via an anode outlet. The electrons are drained from the fuel cell or fuel cell stack and flow, for example, to an electrical consumer. From there the electrons gain access to a cathode of the fuel cell or fuel cell stack, a reduction occuring with cathode air fed to a cathode inlet. After this, the cathode exhaust air is discharged via a cathode outlet. The exhaust gases of the fuel cell stack (depleted reformate) as discharged from both the anode outlet and cathode outlet are then both fed to the afterburner. Here, the depleted reformate is reacted with an afterburner air feed into a combustion exhaust gas. To diagnose system conversion degree, use can be made, for example, of the anode conversion degree. At this time, however, there is no way of measuring the anode conversion degree without having to make recourse to complicated methods of gas analysis of the reformate upstream and downstream of the fuel cell or fuel cell stack. Employing such methods of gas analysis is unfortunately very costly. In addition to this it is most important to diagnose to what extent the components incorporated in the fuel cell system have aged or become degraded, since this can influence the conversion degree of the fuel cell system. This is why prior art makes use of or records so-called predefined voltage-current characteristics in comparing them to a new fuel cell system. Comparing voltage-current characteristics to actual values permits obtaining an indication as to aging of the fuel cell system, for instance. This, however, only relates to an indication of the aging of the system as a whole, not to the individual system components such as, for example, the reformer or fuel cell stack. Since diagnosing particularly the reformer condition is impossible, damage to the fuel cell system may occur due to malperformance of the reformer, resulting in all in curtailing the life of the fuel cell system.

The invention is thus based on the object of sophisticating generic methods and generic fuel cell systems such that diagnosing the condition of a reformer is now possible cost-effectively.

This object is achieved by the features of the independent claims.

Advantageous aspects and further embodiments of the invention read from the dependent claims.

The method in accordance with the invention is a sophistication over generic prior art in that diagnosing the condition of a reformer is performed on the basis of one or more predefined characteristics correlating with an anode conversion degree. This now permits a cost-effective diagnosis and determination possibility, respectively, of malfunctioning of the reformer in on-going operation of the fuel cell system. In addition, this kind of diagnosis as a function of the anode conversion degree is independent of any aging or degradation of the fuel cell stack.

The method in accordance with the invention can be sophisticated to advantage in that the predefined characteristics furthermore correlate to a current drained from a fuel cell or fuel cell stack.

Furthermore, the method in accordance with the invention can be achieved in that the predefined characteristics are each memorized for predefined operating points of the reformer.

In this context the method in accordance with the invention is performed so that the predefined operating points of the reformer are each defined at least by one element from an air ratio of a reformer gas of the reformer and a temperature in the reformer.

In addition, the method in accordance with the invention may also be sophisticated in that diagnosis of the reformer condition is obtained by comparing an anode conversion degree of a predefined characteristic for a predefined operating point of the reformer at a certain current drain to an actual anode conversion degree. This now makes it possible to continuously map functioning of the reformer in on-going operating, resulting in elevated safety from malfunctioning of the reformer.

Likewise, a fuel cell system in accordance with the invention is provided with a controller suitable for implementing the method in accordance with the invention. This results in the properties and advantages as explained in conjunction with the method in accordance with the invention to the same or similar degree and thus reference is made to the comments in this respect as to the method in accordance with the invention to avoid tedious repetition.

The invention will now be detailed by way of particularly preferred embodiments with reference to the attached drawings in which:

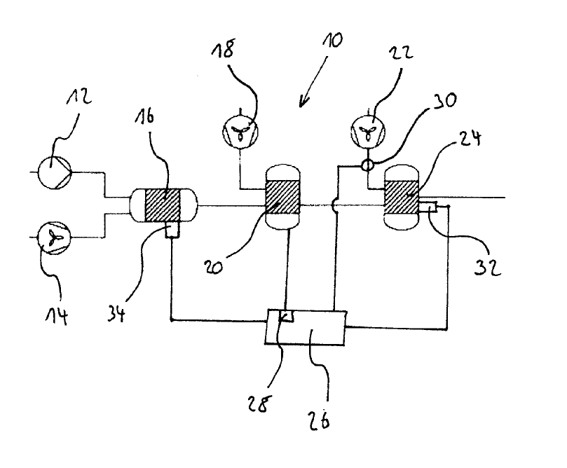

FIG. 1 is a diagrammatic representation of a fuel cell system in accordance with the invention.

Referring now to FIG. 1 there is illustrated a diagrammatic representation of a fuel cell system 10 in accordance with the invention. In the case as shown, the fuel cell system 10 comprises a reformer 16 coupled to an upstream fuel feeder 12 for the fuel supply and an upstream air feeder 14 for the air supply. The reformer 16 is coupled to a down-stream fuel cell stack 20. The fuel cell stack 20 in this case comprises a plurality of fuel cells. However, as an alternative, instead of the fuel cell stack 20 just a single fuel cell may be provided. In particular, the reformer 16 is coupled to an anode of the fuel cell stack 20. In addition, the fuel cell stack 20 is coupled to a cathode air feeder 18 which supplies cathode air to a cathode of the fuel cell stack 20. In addition, the fuel cell stack 20 is coupled to an afterburner 24 which receives a supply of exhaust gas stemming, in this example embodiment, from both the anode and the cathode of the fuel cell stack 20. Coupled furthermore to the afterburner 24 is an afterburner air feeder 22 via which the afterburner 24 receives a supply of afterburner air. Assigned to the fuel cell system 10 is a controller 26. To obtain the air ratio of a reformer gas of the reformer 16 a lambda sensor 34 is provided at the reformer to which the controller 26 is coupled. Likewise provided for sensing the oxygen content or oxygen flow proportion of an afterburner exhaust gas of the afterburner 24 is a further lambda sensor 32 at the afterburner 24. For sensing an air volume flow supplied to the afterburner 24 a flow meter 30 is disposed between the afterburner air feeder 22 and the afterburner 24.

In operation the controller 26 performs the method in accordance with the invention as follows to map the anode conversion degree. Anode conversion degree is defined as the ratio of the combustion gases reacted by the anode to the combustion gases supplied to the anode and can be formulated as follows:

$${X}_{A} = \frac{N \frac{I}{2 F}}{{\sum }_{j = {H}_{2} , CO , BS} {\dot{n}}_{j}^{A , i n}} = \frac{N \frac{I}{2 F}}{N \frac{I}{2 F} + {\dot{n}}_{{H}_{2}}^{A , out} + {\dot{n}}_{CO}^{A , out} + {\dot{n}}_{BS}^{A , out}} .$$

Wherein N is the number of fuel cells of the fuel cell stack, F is the faraday constant in As/mol,

$${\sum }_{j = {H}_{2} , CO , BS} {\dot{n}}_{j}^{A , i n}$$

is the sum of the mol flows of H2, CO and of the fuel in mol/s entering the anode and the term \dot{n}_{H}_{₂}^{A,out}+\dot{n}_{CO}^{A,out}+\dot{n}_{BS}^{A,out} is the sum of the mol flows of H2, CO and of the fuel in mol/s emerging from the anode. So that the controller 26 can map the anode conversion degree it is necessary to sense the current I of the fuel cell stack 20. Preferably the current I is sensed when no additional fuel, particularly Diesel, is supplied to the afterburner 24. To sense the current I the controller 26 features an ammeter 28 suitably connected to the fuel cell stack 20 for sensing the current. If the current of the fuel cell stack 20 can be sensed, it is furthermore necessary to map the term \dot{n}_{H}_{₂}^{A,out}+\dot{n}_{CO}^{A,out}+\dot{n}_{BS}^{A,out} for computing the anode conversion degree X_{A}. This term can be written, among other things, in accordance with the definition of the air ratio as follows:

$${\dot{n}}_{{H}_{2}}^{A , out} + {\dot{n}}_{CO}^{A , out} + {\dot{n}}_{BS}^{A , out} = 2 \frac{1}{{λ}_{NB}} \frac{0.21 \cdot {\dot{V}}_{air}^{NB}}{60 \cdot {V}_{m , air}} .$$

Wherein \dot{V}ₐᵢᵣ^{NB} is the air volume flow entering afterburner 24 from the afterburner air feeder 22 in Nl/s, □_{NB} is the air ratio or Lambda number of the afterburner exhaust gas of the afterburner 24 and V_{m,air} is the mol volume of the air in N1/mol. The mol volume of the air is known and can be obtained, for example, from the mol mass in conjunction with the specific volume of air. The controller 26 detects the air volume flow supplied to the afterburner 24 by means of the flow meter 30. It is then still necessary to compute the air ratio of the afterburner exhaust gas of the afterburner 24 by the controller 26. The air ratio of the afterburner exhaust gas is given by the following formula derivable for super-stoichiometric combustion

$${λ}_{NB} = \frac{1 + ( \frac{2}{{ϕ}^{A , out} ( {H}_{2} , CO )} - 1 ) \cdot {ϕ}_{NB} ( {O}_{2} )}{1 - \frac{{ϕ}_{NB} ( {O}_{2} )}{0.21}} .$$

In this formula, the term φ^{A,out}(H₂,CO) is a volume proportion of H₂ and CO at an anode outlet, in other words the volume proportion of gas leaving the anode, φ_{NB}(O₂) being a volume proportion of O₂ in the afterburner exhaust gas. To obtain the volume proportion of O₂ in the afterburner exhaust gas the controller 26 is coupled to a lambda sensor 32 provided at the afterburner 24. To obtain the volume proportion of H₂ and CO at the anode outlet the controller 26 uses the following formula for the proportion of combustion gas in the anode exhaust gas leaving the anode:

$${ϕ}^{A , out} ( {H}_{2} , CO ) = {ϕ}^{A , i n} ( {H}_{2} , CO ) - I \cdot \frac{1}{{\dot{n}}_{Σ}^{A , i n}} \cdot \frac{N}{2 F} .$$

Wherein φ^{A,in}(H₂,CO) is the volume proportion or part of the gas comprising H₂ and CO supplied to the anode from the reformer 16, i.e. the proportion of H₂ and CO in the reformate, where

$$I \cdot \frac{1}{{\dot{n}}_{Σ}^{A , i n}} \cdot \frac{N}{2 F}$$

is the volume proportion of H₂ and CO converted in the fuel cell stack 20. More particularly, the expression \dot{n}_{Σ}^{A,in} relates to the total mol flow supplied to the anode at the anode inlet. To obtain φ^{A,in}(H₂,CO) the controller 26 uses an empirically established characteristic as a function of a reformer lambda respectively an air ratio of the reformer gas of the reformer 16 and determines

$${ϕ}^{A , i n} ( {H}_{2} , CO ) = {\sum }_{i = 0}^{4} {b}_{i} \cdot {λ}_{Ref}^{i} ,$$

where bᵢ is a predefined coefficient established empirically. To obtain the air ratio of the reformer gas the controller 26 is coupled to a lambda sensor 34 provided at the reformer 16. Likewise to obtain the total mol flow \dot{n}_{Σ}^{A,in} entering the anode the controller 26 uses the following formula:

$${\dot{n}}_{Σ}^{A , i n} = {\dot{n}}_{Σ}^{Ref , i n} \cdot {\sum }_{i = 0}^{2} {a}_{i} \cdot {λ}_{Ref}^{i} .$$

Analogously to the coefficient bᵢ the coefficient aᵢ is also established empirically in this case. It is especially possible with these coefficients as obtained empirically that characteristics can be produced for use in the corresponding calculation. In addition, \dot{n}_{Σ}^{Ref,in} is the notation for a total mol flow of the gases supplied to the reformer 16. This expression can be derived by the following formula for calculating the needed total mol flow entering the reformer \dot{n}_{Σ}^{Ref,in}:

$${\dot{n}}_{Σ}^{Ref , i n} = ( 1 + {λ}_{Ref} \cdot \frac{n + \frac{m}{4}}{0 , 21} ) \cdot \frac{{P}_{Ref}}{{h}_{u , fuel} \cdot {M}_{fuel}} .$$

Wherein n is a carbon proportion and m a hydrogen proportion of the fuel employed respectively supplied to the reformer. In addition P_{Ref} is a reformer power in Watt, h_{u,fuel} is a lower specific calorific value of the fuel in J/kg and M_{fuel} is the mol mass of the fuel, all of these variables being known. Accordingly, when the requirements are satisfied as cited above, the anode conversion degree can be estimated by means of the controller 26, since all variables needed for this purpose are either sensed or derived by the controller 26, as described above, by way of further formulae.

In a further step the anode conversion degree can serve to map the aging or degradation of the reformer 16. To map the latter, it is first necessary to produce predefined characteristic diagrams of the anode conversion degree for specific, predefined operating points of the reformer 16. In this case, for example, a new reformer 16 is used to capture the characteristic diagrams. To define an operating point of the new reformer 16 preferably the air ratio of the reformer gas and the temperature in the new reformer 16 are maintained constant at predefined values. In addition, a predefined electric current is drained from the fuel cell stack 20 and sensed. As a result of which the new reformer 16 furnishes a corresponding combustion gas mol flow given by

$${\sum }_{j = {H}_{2} , CO , BS} {\dot{n}}_{j}^{A , i n} .$$

The anode conversion degree can be sensed and calculated respectively as described above for this operating point of the new reformer 16. The characteristic diagrams of the anode conversion degree for this operating point of the reformer 16 then materializes by varying the electric current drawn. Thereby, a raft of characteristic diagrams for the various predefined operating points of the reformer 16 can be mapped and, for example, saved in a memory of the controller 26. Once the saved characteristic diagrams of the anode conversion degree are known as a function of the current drawn for predefined operating points of the new reformer 16, any deviation from these characteristic diagrams can be “seen” as degradation or aging of the same, but having become aged or degraded reformer 16, when the aged reformer 16 is operated in a same operating point.

It is understood that the features of the invention as disclosed in the above description, in the drawings and as claimed may be essential to achieving the invention both by themselves or in any combination.

### LIST OF REFERENCE NUMERALS

10 fuel cell system

12 fuel feeder

14 air feeder

16 reformer

18 cathode air feeder

20 fuel cell stack

22 afterburner air feeder

24 afterburner

26 controller

28 ammeter

30 flow meter

32 lambda sensor

34 lambda sensor

1. A method for diagnosing a condition of a reformer in a fuel cell system, comprising the step of:
diagnosing the condition of the reformer on the basis of at least one predefined characteristics correlating with an anode conversion degree.

2. The method of claim 1, wherein the predefined characteristics furthermore correlate to a current drawn from a fuel cell or fuel cell stack.

3. The method of claim 1, wherein the predefined characteristics are each memorized for predefined operating points of the reformer.

4. The method of claim 3, wherein the predefined operating points of the reformer are each defined at least by one element from an air ratio of a reformer gas of the reformer and a temperature in the reformer.

5. The method of of claim 3, wherein diagnosing the condition of the reformer is obtained by comparing an anode conversion degree of a predefined characteristic for a predefined operating point of the reformer at a certain current drawn to an actual anode conversion degree.

6. A fuel cell system comprising a controller suitable for performing the method as of of claim 1.
